(19) United States
(12) Patent Application Publication
(10) Pub. No.: US 2021/0398317 A1
(43) Pub. Date: Dec. 23, 2021

(54) INFORMATION PROCESSING DEVICE FOR IDENTIFYING USER WHO WOULD HAVE WRITTEN OBJECT

(71) Applicant: Sharp NEC Display Solutions, Ltd., Tokyo (JP)

(72) Inventor: Toru HIROI, Tokyo (JP)

(21) Appl. No.: 17/466,122

(22) Filed: Sep. 3, 2021

Related U.S. Application Data
(63) Continuation of application No. PCT/JP2019/009300, filed on Mar. 8, 2019.

(51) Int. Cl. G06T 7/73; G06K 9/00

(52) U.S. Cl. CPC G06T 7/73; G06K 9/00255; G06K 9/00268; G06K 9/00416

(57) ABSTRACT

An information processing device includes an acquisition unit configured to acquire detection data by processing a first detection result output from a first sensor configured to detect at least a feature of a user in a nearby region near a display device and to acquire position data by processing a second detection result output from a second sensor configured to detect a position of at least a part of an object in a display image displayed by the display device; and an identification unit configured to identify a user who would have written the object onto the display image by using the detection data and the position data.

### TECHNICAL FIELD

The present invention relates to an information processing device, an information processing method, a program, a display system, and a display method.

### BACKGROUND ART

In recent years, there has been developed a display system in which a user can write an object (for example, a character, a figure, or a symbol) to a display image projected on a projector or displayed on a display using an electronic writing tool.

As described in Patent Literature 1, when a plurality of users write objects to a display image at the same time, the objects are associated with the users who have written the objects. In Patent Literature 1, an electronic writing tool used for writing an object and an object written using the electronic writing tool are associated.

### CITATION LIST

### Patent Literature

[Patent Literature 1]

Japanese Unexamined Patent Application, First Publication No. 2012-194781

### SUMMARY OF INVENTION

### Technical Problem

The present inventor has studied a new method of identifying which user has written which object to a display image.

In an example of an objective of the present invention, which user has written which object to a display image is identified in a new method. Other objectives of the invention will become apparent from the descriptions herein.

### Solution to Problem

According to an aspect of the present invention, an information processing device may include, but is not limited to, an acquisition unit configured to acquire detection data by processing a first detection result output from a first sensor configured to detect at least a feature of a user in a nearby region near a display device and to acquire position data by processing a second detection result output from a second sensor configured to detect a position of at least a part of an object in a display image displayed by the display device; and an identification unit configured to identify a user who would have written the object onto the display image by using the detection data and the position data.

According to another aspect of the present invention, an information processing method may include, but is not limited to, acquiring detection data by processing a first detection result output from a first sensor configured to detect at least a feature of a user in a nearby region near a display device; acquiring position data by processing a second detection result output from a second sensor configured to detect a position of at least a part of an object in a display image displayed by the display device; and identifying a user who would have written the object onto the display image by using the detection data and the position data.

According to yet another aspect of the present invention, a non-transitory computer readable storage medium that stores a computer program, which when executed by a computer, causes the computer to: acquire detection data by processing a first detection result output from a first sensor configured to detect at least a feature of a user in a nearby region near a display device; acquire position data by processing a second detection result output from a second sensor configured to detect a position of at least a part of an object in a display image displayed by the display device; and identify a user who would have written the object onto the display image by using the detection data and the position data.

According to still another aspect of the present invention, a display system may include, but is not limited to, a display device; and an information processing device. The information processing device may include, but is not limited to, an acquisition unit configured to acquire detection data by processing a first detection result output from a first sensor configured to detect at least a feature of a user in a nearby region near a display device and to acquire position data by processing a second detection result output from a second sensor configured to detect a position of at least a part of an object in a display image displayed by the display device; and an identification unit configured to identify a user who would have written the object onto the display image by using the detection data and the position data.

According to still another aspect of the present invention, a display method may include, but is not limited to, detecting at least a user in a nearby region near a display device and a position of the user when an object is written into a display image displayed by the display device; and causing the display device to display, on the display image, using information of at least the position, an object which is associated with the user and which is in a corresponding form that corresponds to the user.

### Advantageous Effects of Invention

According to an aspect of the present invention, it is possible to identify which user has written which object to a display image in a new method.

### BRIEF DESCRIPTION OF DRAWINGS

The above-described objectives and other objectives, features and advantages will be further clarified by the preferred embodiments described below and the accompanying drawings below.

FIG. 1 is a diagram for describing a display system according to Embodiment 1.

FIG. 2 is a flowchart showing an example of an operation of the display system shown in FIG. 1.

FIG. 3 is a diagram for describing a display system according to Embodiment 2.

FIG. 4 is a flowchart showing an example of an operation of the display system shown in FIG. 3.

FIG. 5 is a diagram for describing a display system according to Embodiment 3.

FIG. 6 is a flowchart showing an example of an operation of the display system shown in FIG. 5.

FIG. 7 is an exploded perspective view of a display system according to Embodiment 4.

FIG. 8 is a diagram showing an example of a hardware configuration of an information processing device according to Embodiment 5.

### DESCRIPTION OF EMBODIMENTS

Hereinafter, embodiments of the present invention will be described with reference to the drawings. In all drawings, similar components are designated by similar reference signs and description thereof will be appropriately omitted.

### Embodiment 1

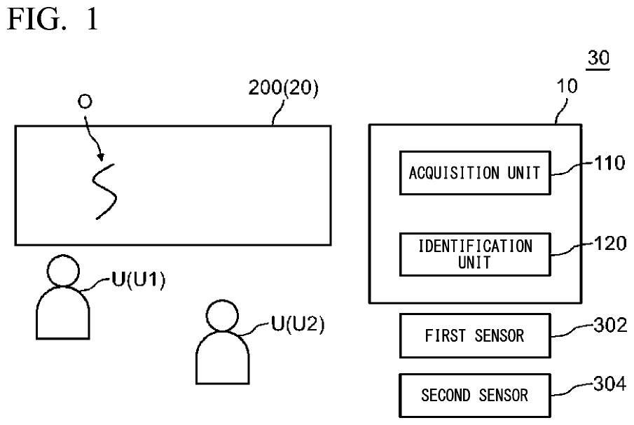

FIG. 1 is a diagram for describing a display system 30 according to Embodiment 1.

The display system 30 includes an information processing device 10, a display device 20, a first sensor 302, and a second sensor 304. The display device 20 displays a display image 200.

An outline of the information processing device 10 will be described with reference to FIG. 1. The information processing device 10 includes an acquisition unit 110 and an identification unit 120. The acquisition unit 110 acquires detection data and position data. The detection data is by processing a detection result output from the first sensor 302. The first sensor 302 is used for detecting a feature of at least one user U in a nearby region near the display device 20. The position data is by processing the detection result output from the second sensor 304. The second sensor 304 is used for detecting a position of at least a part of an object O within the display image 200. The identification unit 120 identifies the user U who would have written the object O to the display image 200 using the detection data and the position data acquired by the acquisition unit 110. Also, the identification unit 120 does not necessarily have to identify a unique attribute of the user U and it is only necessary for the identification unit 120 to identify the user U to the extent that one user U can be identified from another user U.

According to the present embodiment, it is possible to identify which user U has written which object O to the display image 200 in a new method. In particular, according to the present embodiment, it is possible to easily identify which user U has written which object O to the display image 200. Specifically, in the present embodiment, the identification unit 120 can identify a corresponding relationship between an object written to the display image 200 and a user U who would have written the object using the detection data representing a feature of at least one user U and the position data representing a position of at least a part of the object O. Therefore, it is possible to easily identify which user U has written which object O to the display image 200.

Further, according to the display method according to the present embodiment, when the object O is written to the display image 200, at least the user U and the position thereof in the nearby region near the display device 20 are detected. In this method, at least information of the position can be used to display the object O associated with the user U on the display image 200 in a form according to the user U.

The object O is superimposed and displayed on the display image 200 on the basis of a result of detecting a position of at least a part of the object O in the display image 200. The display system 30 can identify the position of at least the part of the object O within the display image 200 using, for example, the detection result of the second sensor 304.

The acquisition unit 110 may acquire the detection data via one interface (for example, one of wired and wireless interfaces) and acquire the position data via another interface different from the one interface (for example, the other of the wired and wireless interfaces). Alternatively, the acquisition unit 110 may acquire both the detection data and the position data via a common interface (for example, one of wired and wireless interfaces).

Details of the information processing device 10 will be described with reference to FIG. 1.

In an example, the display device 20 is a projector. In this example, the display image 200 may be an image projected on a projection surface (for example, a screen or a wall) by the projector (the display device 20). In another example, the display device 20 is a display. In the present example, the display image 200 may be an image displayed on the display surface by the display (the display device 20). The display image 200 is implemented by, for example, an electronic blackboard.

A plurality of users U are located in the nearby region near the display device 20. In the example shown in FIG. 1, the plurality of users U are located in front of the display image 200. A user U1 writes the object O onto the display image 200 using an electronic writing tool (not shown). A user U2 is farther away from the object O than the user U1 is.

The first sensor 302 and the second sensor 304 may be sensors disposed separately from each other or may be a common sensor.

The first sensor 302 detects at least one feature of a user U within the nearby region near the display device 20. The feature of the user U may be a feature for identifying one user U from another user U or a feature for identifying a unique attribute of the user U. The feature of the user U is, for example, the face of the user U, the body of the user U, the movement of the user U, or a combination thereof.

The first sensor 302 may be a device capable of detecting an image including at least one user U through, for example, imaging or optical scanning The first sensor 302 can be, for example, a single camera, a stereo camera, an infrared sensor, motion capture, an optical scanner (for example, a dot projector) or a combination thereof. In the present example, the detection result of the first sensor 302 includes an image including at least one user U within the nearby region near the display device 20.

A position where the first sensor 302 is provided is not limited to a specific position. The first sensor 302 may be attached to the display image 200 or may be disposed away from the display image 200. When the first sensor 302 is attached to the display image 200, a position and an orientation of the first sensor 302 with respect to the display image 200 may be fixed.

The detection data acquired by the acquisition unit 110 is by processing the detection result of the first sensor 302. For example, when the detection result of the first sensor 302 is an image, the detection data is by processing the image detected by the first sensor 302. A place where the detection result of the first sensor 302 is processed is not particularly limited. For example, the detection result of the first sensor 302 may be processed inside the information processing device 10 (for example, the acquisition unit 110) or outside the information processing device 10 (for example, in an external network).

The second sensor 304 detects the position of at least a part of the object O within the display image 200. For example, the first sensor 302 detects at least one position from a start of writing of the object O to an end of writing of the object O, or at least one position on a trajectory of stroke of writing as the object, where the trajectory of stroke is defined between a start point of writing to an end point of writing. For example, the acquisition unit 110 may calculate an average of positions detected by the second sensor 304 or may calculate the center of gravity of the object O using the positions through the second sensor 304.

The second sensor 304 may be, for example, a device capable of detecting an image including the display image 200 through imaging. The second sensor 304 is, for example, an imaging device (for example, a camera). In this example, the acquisition unit 110 can acquire the position data by processing the image detected by the second sensor 304. Specifically, for example, the acquisition unit 110 processes the image detected by the second sensor 304 to detect the orientation of the display image 200 in the image, a predetermined reference position (for example, one corner of the display image 200) within the display image 200 within the image, and the position of the object O within the display image 200 within the image. The acquisition unit 110 can calculate a relative position of the object O with respect to the reference position and acquire the position data of the object O using the calculated position and the orientation of the display image 200.

The second sensor 304 may be a device for detecting a position of the display image 200 in contact with or in proximity to an electronic writing tool (not shown) for use in writing of the object O (for example, a contact sensor or a proximity sensor provided in the display image 200). For example, when the display device 20 (the display image 200) is a touch panel, the touch panel can also function as the sensor.

The image detected by the second sensor 304 may be captured in a direction different from the direction in which the image detected by the first sensor 302 has been captured. Alternatively, the first sensor 302 may function as the second sensor 304 and the image detected by the second sensor 304 (the first sensor 302) may include an image including at least one user U within the nearby region near the display device 20 and the display image 200.

The position data acquired by the acquisition unit 110 is by processing the detection result of the second sensor 304. For example, when the detection result of the second sensor 304 is an image, the position data is by processing the image detected by the second sensor 304. Further, when the detection result of the second sensor 304 is a sensing result of the contact sensor or the proximity sensor, the position data is by processing the sensing result detected by the second sensor 304. A place where the detection result of the second sensor 304 is processed is not particularly limited. For example, the detection result of the second sensor 304 may be processed inside the information processing device 10 (for example, the acquisition unit 110) or outside the information processing device 10 (for example, in an external network).

The second sensor 304 may detect whether or not the object O has been written to the display image 200.

The identification unit 120 identifies the user U who would have written the object O to the display image 200 using the detection data and the position data.

The detection data may include first data representing the position of the user U located within the nearby region near the display device 20. In this case, the identification unit 120 may identify the user who would have written the object O on the basis of the position of the user U represented by the first data and the position of at least a part of the object O represented by the position data. In this example, the first data may include an image including the user U within the nearby region near the display device 20. In this case, for example, one frame image includes a plurality of users U.

The first data may represent positions of a plurality of users U (the user U1 and the user U2) located within the nearby region near the display device 20. In this case, the identification unit 120 may identify the user U located nearest the object O among the plurality of users U as the user U who would have written the object O on the basis of a position of each of the plurality of users U represented by the first data and a position of at least a part of the object O represented by the position data.

The detection data may include second data representing at least a part of the face of the user U located within the nearby region near the display device 20. The second data may include an image that includes at least the part of the face of the user U. The identification unit 120 further identifies the user U who would have written the object O on the basis of the orientation of the line of sight or the orientation of the face of the user U determined from the second data.

For example, the orientation of the line of sight or the orientation of the face of the user U can be detected by imaging at least a part (for example, an eye) of the face of the user U using a stereo camera or scanning at least a part of the face of the user U using an optical scanner (for example, a dot projector).

The detection data may include third data representing at least a part (for example, an arm) of the body of the user U located within the nearby region near the display device 20. The third data may include an image including at least the part of the body of the user U. The identification unit 120 further identifies the user U who would have written the object O on the basis of the operation of the user U determined from the third data.

For example, the operation of the user U can be detected by imaging at least a part (for example, an arm) of the body of the user U using a stereo camera or scanning at least a part of the body of the user U using an optical scanner (for example, a dot projector).

Although there are a plurality of users U (the user U1 and the user U2) in the nearby region near the display device 20 in the example shown in FIG. 1, a case in which there is only one user U in the nearby region near the display device 20 can also be applied to the present embodiment. For example, when one user U1 enters the nearby region near the display device 20, writes the object O, and leaves the nearby region near the display device 20 and then another user U2 enters the nearby region near the display device 20, writes the object O, and leaves the nearby region near the display device 20, the identification unit 120 can identify the first user U1 who would have written the object O using the detection data (a feature of the user U1) and the position data (a position of at least a part of the object O written by the user U1) and can identify the second user U2 who would have written the object O using the detection data (a feature of the user U2) and the position data (a position of at least a part of the object O written by the user U2).

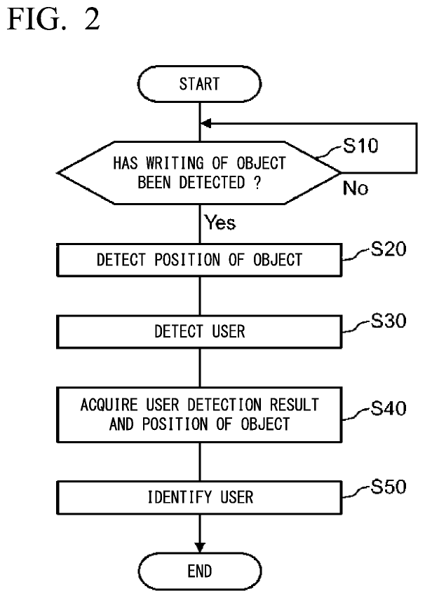

FIG. 2 is a flowchart showing an example of the operation of the display system 30 shown in FIG. 1.

First, the second sensor 304 detects whether or not the object O has been written to the display image 200 until the object O has been written to the display image 200 (step S10: No) (step S10). When the second sensor 304 detects that the object O has been written (step S10: Yes), the second sensor 304 detects a position where the object O has been written to the display image 200 (step S20). Subsequently, the first sensor 302 detects at least one user U located within the nearby region near the display device 20 (step S30). Also, steps S20 and S30 may be carried out at the same time or may be carried out in the order of steps S30 and S20. Subsequently, the acquisition unit 110 acquires the detection data from the first sensor 302 and acquires the position data from the second sensor 304 (step S40). Subsequently, the identification unit 120 identifies the user U who would have written the object O to the display image 200 using the detection data and the position data (step S50).

### Embodiment 2

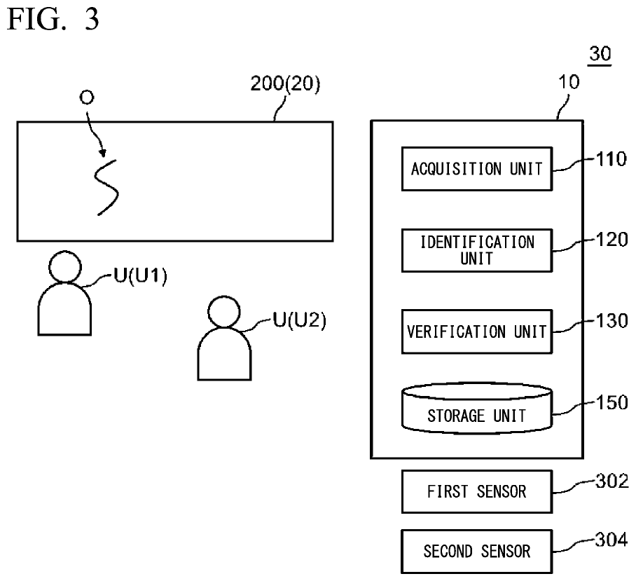

FIG. 3 is a diagram for describing a display system 30 according to Embodiment 2. The display system 30 according to Embodiment 2 is similar to the display system 30 according to Embodiment 1 except for the following differences.

The information processing device 10 further includes a verification unit 130 and a storage unit 150. The storage unit 150 pre-stores at least one predetermined user. The verification unit 130 verifies whether a user U detected in the detection data is identical with a user pre-stored in the storage unit 150. When the verification unit 130 determines that the user U detected in the detection data is identical with the user pre-stored in the storage unit 150, the identification unit 120 identifies the user U who would have written the object O to the display image 200.

According to the present embodiment, the user U who would have written the object O to the display image 200 can be identified with high accuracy. Specifically, in the present embodiment, the identification unit 120 can identify the user U who would have written the object O to the display image 200 from the users pre-stored in the storage unit 150. Therefore, the user U who would have written the object O to the display image 200 can be identified with high accuracy.

The detection data may include an image including at least one user U within the nearby region near the display device 20. This image includes at least a part (for example, a face or a body) of the user U, in particular, the face of the user U.

The verification unit 130 may use a feature quantity of the face of the user U to verify whether the user U detected in the detection data is identical with the user pre-stored in the storage unit 150. The verification unit 130 can calculate the feature quantity of the face of the user U by analyzing the image including the face of the user U. The storage unit 150 may pre-store the feature quantity of the face of the user. The verification unit 130 can verify whether or not the user U detected in the detection data is identical with the user pre-stored in the storage unit 150 by comparing the feature quantity detected in the detection data with the feature quantity stored in the storage unit 150.

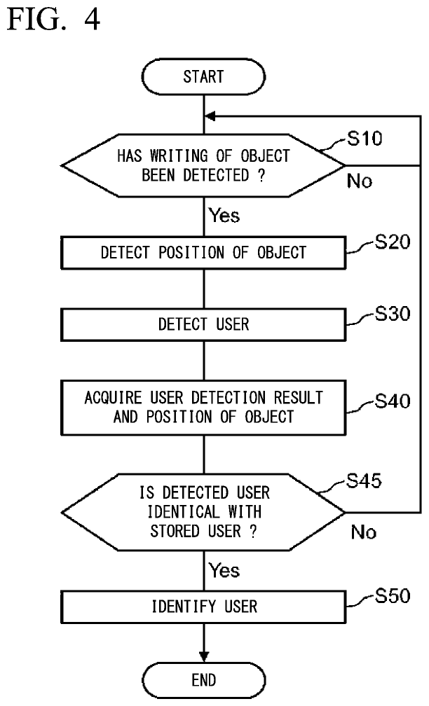

FIG. 4 is a flowchart showing an example of an operation of the display system 30 shown in FIG. 3.

Steps S10, S20, S30, and S40 are similar to steps S10, S20, S30, and S40 shown in FIG. 2, respectively. After step S40, the verification unit 130 verifies whether the user U detected in the detection data is identical with the user stored in the storage unit 150 (step S45). When the verification unit 130 determines that the user U detected in the detection data is identical with the user stored in the storage unit 150 (step S45: Yes), the identification unit 120 identifies the user U who would have written the object O to the display image 200 (step S50). When the verification unit 130 determines that the user U detected in the detection data is not identical with the user stored in the storage unit 150 (step S45: No), the process returns to step S10.

### Embodiment 3

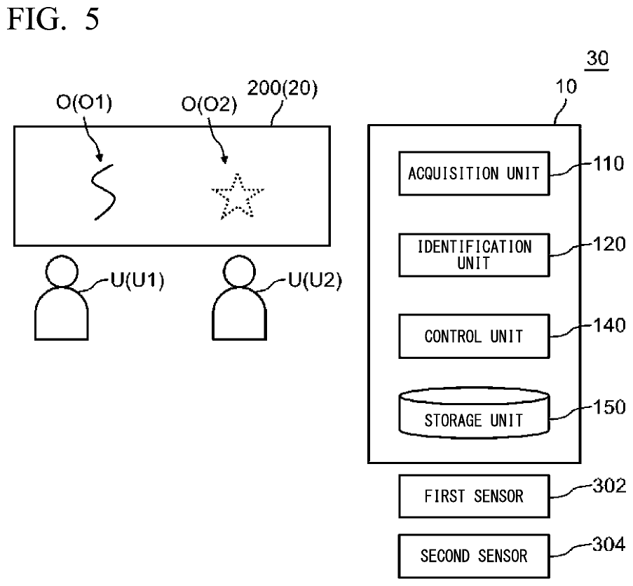

FIG. 5 is a diagram for describing a display system 30 according to Embodiment 3. The display system 30 according to Embodiment 3 is similar to the display system 30 according to Embodiment 1 except for the following difference.

The information processing device 10 further includes a control unit 140. The control unit 140 causes an object O to be displayed on the display image 200 in a different form in accordance with the user U identified by the identification unit 120.

According to the present embodiment, it becomes easy to display the object O on the display image 200 in a different form in accordance with the user U. In particular, according to the present embodiment, even if a plurality of users U write the objects O at the same time, it becomes easy to display the objects O on the display image 200 in different forms in accordance with the users U. Specifically, in the present embodiment, the identification unit 120 can easily identify a corresponding relationship between the object O written to the display image 200 and the user U who would have written the object O using the detection data of at least one user U and the position data of the object O. Using this corresponding relationship, the control unit 140 can cause the object O to be displayed on the display image 200 in a different form in accordance with the user U. Therefore, even if a plurality of users U write the objects O at the same time, it becomes easy to display the objects O on the display image 200 in different forms in accordance with the users U.

The form of the object O may include, for example, at least one of a color and a shape of a line of the object O. The shape of the line of the object O includes, for example, at least one of a thickness of the line and a type of the line (for example, a solid line, a broken line, an alternate long and short dash line, or a double line). In the example shown in FIG. 5, the line of the object O1 of the user U1 is a solid line and the line of the object O2 of the user U2 is a broken line.

The form of the object O may differ in accordance with an individual attribute of the user U. For example, when there are a user A, a user B, and a user C, the form of the object O of the user A, the form of the object O of the user B, and the form of the object O of the user C can be different from each other. In this case, it becomes easy to identify which user U has written the object O.

The form of the object O may differ in accordance with an attribute of a group to which the user U belongs. For example, when there are users A1 and A2 belonging to a group A and users B1 and B2 belonging to a group B, the form of the object O of the user A1 and the form of the object O of the user A2 can be the same, the form of the object O of the user B1 and the form of the object O of the user B2 can be the same, and the forms of the objects O of the users A1 and A2 can be different from the forms of the objects O of the users B1 and B2. In this case, it becomes easy to identify a group to which the user U belongs when the object O is written.

In the above-described control, the identification unit 120 may store a corresponding relationship between the object O written to the display image 200 and the user U who would have written the object O in the storage unit 150. The control unit 140 can determine a form in which the object O is displayed using this corresponding relationship.

The control of the display image 200 by the control unit 140 is not limited to the above-described example and may include, for example, the following example.

The control unit 140 may display attribute information (for example, a name or a face photograph) of the user U on the display image 200 in the vicinity of the object O. For example, when the user A writes the object A1, the control unit 140 can cause the attribute information of the user A to be displayed on the display image 200 in the vicinity of the object A1. In this example, the storage unit 150 may pre-store the attribute information of the user in association with the feature quantity of the user (for example, the feature quantity of the face of the user U). The control unit 140 can read the feature quantity of the user and the attribute information of the user from the storage unit 150 and determine the attribute information of the user U with reference to the feature quantity of the user U detected in the detection data. In this case, it becomes easy to identify a user U who would have written the object O.

The control unit 140 may not allow a user U different from the user U who would have written the object O to edit the object O in the display image 200. For example, when the user A has written the object A1, the control unit 140 can prevent the user B different from the user A from editing the user Al in the display image 200. The control unit 140 can read the feature quantity of the user from the storage unit 150 and determine whether or not the object O is allowed to be edited in the display image 200 with reference to the feature quantity of the user U detected in the detection data.

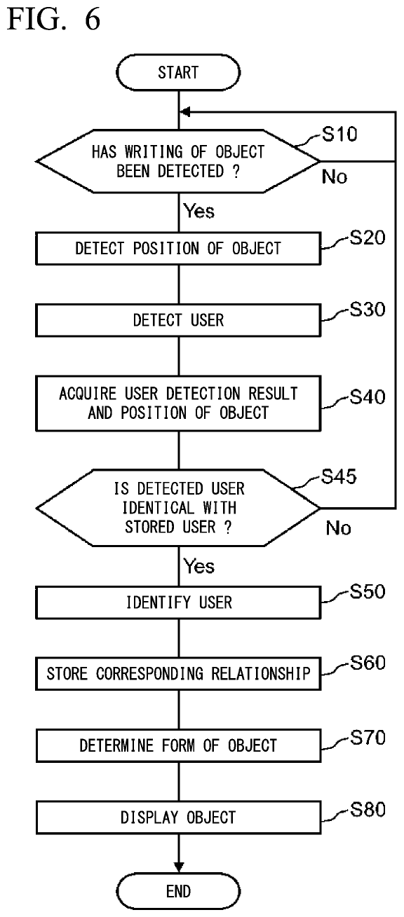

FIG. 6 is a flowchart showing an example of the operation of the display system 30 shown in FIG. 5.

Steps S10, S20, 30, S40, S45, and S50 are similar to steps S10, S20, 30, S40, S45, and S50 shown in FIG. 4, respectively. After step S50, the identification unit 120 causes the storage unit 150 to store a corresponding relationship between the object O written to the display image 200 and the user U who would have written the object O (step S60). Subsequently, the control unit 140 determines a form in which the object O is displayed using the corresponding relationship stored in the storage unit 150 (step S70). Subsequently, the control unit 140 causes the object O to be displayed on the display image 200 in the determined form (step S80). In this way, the control unit 140 causes the object O to be displayed on the display image 200 in a different form in accordance with the user U.

### Embodiment 4

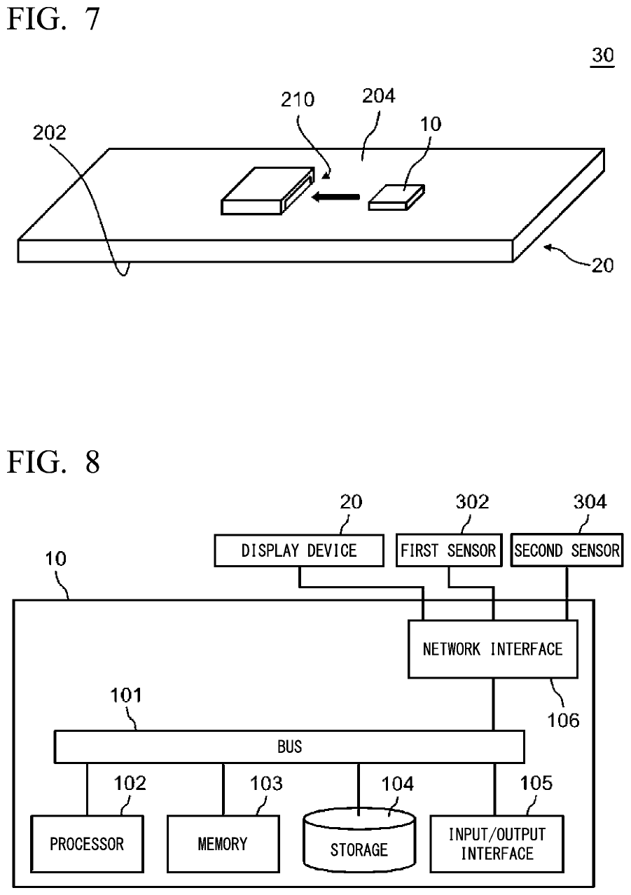

FIG. 7 is an exploded perspective view of a display system 30 according to Embodiment 4.

The display device 20 has a first surface 202 and a second surface 204. An object O is written on the first surface 202. The second surface 204 is on the opposite side of the first surface 202 and is the back surface of the display device 20.

A recess 210 is formed on the side of the second surface 204. The information processing device 10 can be inserted into the recess 210. In the example shown in FIG. 7, the information processing device 10 is a microcomputer. When the information processing device 10 has been inserted into the recess 210, the information processing device 10 is electrically connected to the display device 20 so that signals can be transmitted and received between the information processing device 10 and the display device 20. The recess 210 may be formed on the first surface 202 side.

### Embodiment 5

FIG. 8 is a diagram showing an example of a hardware configuration of an information processing device 10 according to Embodiment 5.

A main configuration of the information processing device 10 is implemented by using an integrated circuit. This integrated circuit includes a bus 101, a processor 102, a memory 103, a storage device 104, an input/output interface 105, and a network interface 106.

The bus 101 is a data transmission path for the processor 102, the memory 103, the storage device 104, the input/output interface 105, and the network interface 106 to transmit and receive data to and from each other. However, a method of connecting the processor 102 and the like to each other is not limited to a bus connection.

The processor 102 is an arithmetic processing unit implemented using a microprocessor or the like.

The memory 103 is a memory implemented using a random access memory (RAM) or the like.

The storage device 104 is a storage device implemented using a read only memory (ROM), a flash memory, or the like.

The input/output interface 105 is an interface for connecting the information processing device 10 to a peripheral device.

The network interface 106 is an interface for connecting the information processing device 10 to the communication network. The method of connecting the network interface 106 to the communication network may be a wireless connection or a wired connection. The information processing device 10 is connected to the display device 20, the first sensor 302, and the second sensor 304 via the network interface 106.

The storage device 104 stores a program module for implementing each functional element of the information processing device 10. The processor 102 implements each function of the information processing device 10 by reading the program module into the memory 103 and executing the program module. The storage device 104 also functions as a storage unit 150.

Also, the hardware configuration of the integrated circuit described above is not limited to the configuration shown in FIG. 8. For example, the program module may be stored in the memory 103. In this case, the integrated circuit may not include the storage device 104.

Although embodiments of the present invention have been described above with reference to the drawings, these are examples of the present invention and various configurations other than the above can be adopted.

Hereinafter, examples of embodying the invention will be described.

In some embodiments, an information processing device may include, but is not limited to, an acquisition unit configured to acquire detection data by processing a first detection result output from a first sensor configured to detect at least a feature of a user in a nearby region near a display device and to acquire position data by processing a second detection result output from a second sensor configured to detect a position of at least a part of an object in a display image displayed by the display device; and an identification unit configured to identify a user who would have written the object onto the display image by using the detection data and the position data.

In some cases, the detection data includes first data representing a position of the user located within the nearby region, and the identification unit is configured to identify the user who would have written the object, on the basis of the position of the user represented by the first data and a position of at least a part of the object represented by the position data.

In some cases, the detection data includes second data representing at least a part of a face of the user located within the nearby region. The identification unit is configured to determine, from the second data, at least one of an orientation of a line of sight of the user and an orientation of a face of the user. The identification unit is configured to identify the user who would have written the object, on the basis of the at least one of the orientation of the line of sight of the user and the orientation of the face of the user.

In some cases, the detection data includes third data representing at least a part of a body of the user located within the nearby region. The identification unit is configured to determine, from the third data, an operation of the user. The identification unit is configured to identify the user who would have written the object, on the basis of the operation of the user.

In some cases, the position of at least a part of the object represented by the position data includes at least one position on a trajectory of stroke of writing as the object, where the trajectory of stroke is defined between a start point of writing to an end point of writing.

In some cases, the first data represents a respective position of each of the plurality of users located within the nearby region. The identification unit is configured to identify a user located nearest the object among the plurality of users as the user who would have written the object on the basis of a respective position of each of the plurality of users represented by the first data and the position of at least a part of the object represented by the position data.

In some cases, the second sensor includes at least one of an image senor configured to detect an image including the display image and a position sensor configured to detect a position at which an electronic writing tool for writing in contact with or in proximity to a display screen of the display device.

In some cases, the information processing device may further include, but is not limited to, a verification unit configured to verify whether a user detected in the detection data is identical with a user pre-stored in a storage device. The identification unit is configured to identify the user who would have written the object onto the display image if the verification unit determined that the user detected in the detection data is identical with the user pre-stored in the storage device.

In some cases, the information processing device may further include, but is not limited to, a control unit configured to cause the display device to display the object on the display image, wherein the object is in a respective form which corresponds to each user identified by the identification unit.

In some cases, the detection data includes an image including the at least one user within the nearby region.

In some cases, the acquisition unit is configured to acquire another image captured in a direction different from a direction in which the image has been captured and including the display image and to acquire the position data of the object using the other image.

In some cases, the image includes the display image. The acquisition unit is configured to acquire the position data of the object, using the image.

In some cases, the object is superimposed on the display image on the basis of a result of detecting the position of at least a part of the object within the display image.

In some cases, the acquisition unit is configured to acquire the detection data via one interface and acquires the position data via another interface different from the one interface.

In other embodiments, an information processing method may include, but is not limited to, acquiring detection data by processing a first detection result output from a first sensor configured to detect at least a feature of a user in a nearby region near a display device; acquiring position data by processing a second detection result output from a second sensor configured to detect a position of at least a part of an object in a display image displayed by the display device; and identifying a user who would have written the object onto the display image by using the detection data and the position data.

In some cases, the detection data includes first data representing a position of the user located within the nearby region, and the user who would have written the object is identified, on the basis of the position of the user represented by the first data and a position of at least a part of the object represented by the position data.

In some cases, the detection data includes second data representing at least a part of a face of the user located within the nearby region. The method also includes determining, from the second data, at least one of an orientation of a line of sight of the user and an orientation of a face of the user. The user who would have written the object is identified, on the basis of the at least one of the orientation of the line of sight of the user and the orientation of the face of the user.

In some cases, the detection data includes third data representing at least a part of a body of the user located within the nearby region. The method also includes determining, from the third data, an operation of the user. The user who would have written the object is identified, on the basis of the operation of the user.

In some cases, the position of at least a part of the object represented by the position data includes at least one position on a trajectory of stroke of writing as the object, where the trajectory of stroke is defined between a start point of writing to an end point of writing.

In some cases, the first data represents a respective position of each of the plurality of users located within the nearby region. A user located nearest the object among the plurality of users is identified as the user who would have written the object on the basis of a respective position of each of the plurality of users represented by the first data and the position of at least a part of the object represented by the position data.

In some cases, the method also includes detecting an image including the display image and/or detecting a position at which an electronic writing tool for writing in contact with or in proximity to a display screen of the display device.

In some cases, the method may further includes verifying whether a user detected in the detection data is identical with a user pre-stored in a storage device. The user who would have written the object onto the display image is identified if the verification unit determined that the user detected in the detection data is identical with the user pre-stored in the storage device.

In some cases, the method also includes causing a display device to display the object on the display image, wherein the object is in a respective form which corresponds to each user identified by the identification process.

In some cases, the detection data includes an image including the at least one user within the nearby region.

In some cases, the method also includes acquiring another image captured in a direction different from a direction in which the image has been captured and including the display image and acquiring the position data of the object using the other image.

In some cases, the image includes the display image. The position data of the object is acquired using the image.

In some cases, the object is superimposed on the display image on the basis of a result of detecting the position of at least a part of the object within the display image.

In some cases, the method also includes acquiring the detection data via one interface and acquiring the position data via another interface different from the one interface.

In still other embodiments, a non-transitory computer readable storage medium that stores a computer program, which when executed by a computer, causes the computer to: acquire detection data by processing a first detection result output from a first sensor configured to detect at least a feature of a user in a nearby region near a display device; acquire position data by processing a second detection result output from a second sensor configured to detect a position of at least a part of an object in a display image displayed by the display device; and identify a user who would have written the object onto the display image by using the detection data and the position data.

In yet other embodiments, a display system may include, but is not limited to, a display device; and an information processing device. The information processing device may include, but is not limited to, an acquisition unit configured to acquire detection data by processing a first detection result output from a first sensor configured to detect at least a feature of a user in a nearby region near a display device and to acquire position data by processing a second detection result output from a second sensor configured to detect a position of at least a part of an object in a display image displayed by the display device; and an identification unit configured to identify a user who would have written the object onto the display image by using the detection data and the position data.

In some cases, the detection data includes first data representing a position of the user located within the nearby region, and the identification unit is configured to identify the user who would have written the object, on the basis of the position of the user represented by the first data and a position of at least a part of the object represented by the position data.

In some cases, the detection data includes second data representing at least a part of a face of the user located within the nearby region. The identification unit is configured to determine, from the second data, at least one of an orientation of a line of sight of the user and an orientation of a face of the user. The identification unit is configured to identify the user who would have written the object, on the basis of the at least one of the orientation of the line of sight of the user and the orientation of the face of the user.

In some cases, the detection data includes third data representing at least a part of a body of the user located within the nearby region. The identification unit is configured to determine, from the third data, an operation of the user. The identification unit is configured to identify the user who would have written the object, on the basis of the operation of the user.

In some cases, the position of at least a part of the object represented by the position data includes at least one position on a trajectory of stroke of writing as the object, where the trajectory of stroke is defined between a start point of writing to an end point of writing.

In some cases, the first data represents a respective position of each of the plurality of users located within the nearby region. The identification unit is configured to identify a user located nearest the object among the plurality of users as the user who would have written the object on the basis of a respective position of each of the plurality of users represented by the first data and the position of at least a part of the object represented by the position data.

In some cases, the second sensor includes at least one of an image senor configured to detect an image including the display image and a position sensor configured to detect a position at which an electronic writing tool for writing in contact with or in proximity to a display screen of the display device.

In some cases, the information processing device may further include, but is not limited to, a verification unit configured to verify whether a user detected in the detection data is identical with a user pre-stored in a storage device. The identification unit is configured to identify the user who would have written the object onto the display image if the verification unit determined that the user detected in the detection data is identical with the user pre-stored in the storage device.

In some cases, the information processing device may further include, but is not limited to, a control unit configured to cause the display device to display the object on the display image, wherein the object is in a respective form which corresponds to each user identified by the identification unit. In some cases, the detection data includes an image including the at least one user within the nearby region.

In some cases, the acquisition unit is configured to acquire another image captured in a direction different from a direction in which the image has been captured and including the display image and to acquire the position data of the object using the other image.

In some cases, the image includes the display image. The acquisition unit is configured to acquire the position data of the object, using the image.

In some cases, the object is superimposed on the display image on the basis of a result of detecting the position of at least a part of the object within the display image. In some cases, the acquisition unit is configured to acquire the detection data via one interface and acquires the position data via another interface different from the one interface.

In additional embodiments, a display method may include, but is not limited to, detecting at least a user in a nearby region near a display device and a position of the user when an object is written into a display image displayed by the display device; and causing the display device to display, on the display image, using information of at least the position, an object which is associated with the user and which is in a corresponding form that corresponds to the user.

While embodiments of the invention have been described above, the invention is not limited to the embodiments and can be subjected to various modifications and replacements without departing from the gist of the invention. The configurations described in the aforementioned embodiments and examples may be appropriately combined.

Some or all of the functions of the constituent units of the multi-display systems according to the aforementioned embodiments may be realized by recording a program for realizing the functions on a computer-readable recording medium and causing a computer system to read and execute the program recorded on the recording medium. The “computer system” mentioned herein may include an operating system (OS) or hardware such as peripherals.

Examples of the “computer-readable recording medium” include a portable medium such as a flexible disk, a magneto-optical disc, a ROM, or a CD-ROM and a storage device such as a hard disk incorporated in the computer system. The “computer-readable recording medium” may include a medium that dynamically holds a program for a short time like a communication line when a program is transmitted via a network such as the Internet or a communication circuit such as a telephone circuit and a medium that holds a program for a predetermined time like a volatile memory in a computer system serving as a server or a client in that case. The program may serve to realize some of the aforementioned functions. The program may serve to realize the aforementioned functions in combination with another program stored in advance in the computer system.

What is claimed is:

1. An information processing device comprising:
an acquisition unit configured to acquire detection data by processing a first detection result output from a first sensor configured to detect at least a feature of a user in a nearby region near a display device and to acquire position data by processing a second detection result output from a second sensor configured to detect a position of at least a part of an object in a display image displayed by the display device; and
an identification unit configured to identify a user who would have written the object onto the display image by using the detection data and the position data.

2. The information processing device according to claim 1,
wherein the detection data includes first data representing a position of the user located within the nearby region, and
wherein the identification unit is configured to identify the user who would have written the object, on the basis of the position of the user represented by the first data and a position of at least a part of the object represented by the position data.

3. The information processing device according to claim 2,
wherein the detection data includes second data representing at least a part of a face of the user located within the nearby region;
wherein the identification unit is configured to determine, from the second data, at least one of an orientation of a line of sight of the user and an orientation of a face of the user; and
wherein the identification unit is configured to identify the user who would have written the object, on the basis of the at least one of the orientation of the line of sight of the user and the orientation of the face of the user.

4. The information processing device according to claim 2,
wherein the detection data includes third data representing at least a part of a body of the user located within the nearby region, and
wherein the identification unit is configured to determine, from the third data, an operation of the user;
wherein the identification unit is configured to identify the user who would have written the object, on the basis of the operation of the user.

5. The information processing device according to claim 2, wherein the position of at least a part of the object represented by the position data includes at least one position on a trajectory of stroke of writing as the object, where the trajectory of stroke is defined between a start point of writing to an end point of writing.

6. The information processing device according to claim 2,
wherein the first data represents a respective position of each of the plurality of users located within the nearby region, and
wherein the identification unit is configured to identify a user located nearest the object among the plurality of users as the user who would have written the object on the basis of a respective position of each of the plurality of users represented by the first data and the position of at least a part of the object represented by the position data.

7. The information processing device according to claim 1,
wherein the second sensor includes at least one of an image senor configured to detect an image including the display image and a position sensor configured to detect a position at which an electronic writing tool for writing in contact with or in proximity to a display screen of the display device.

8. The information processing device according to claim 1, further comprising:
a verification unit configured to verify whether a user detected in the detection data is identical with a user pre-stored in a storage device,
wherein the identification unit is configured to identify the user who would have written the object onto the display image if the verification unit determined that the user detected in the detection data is identical with the user pre-stored in the storage device.

9. The information processing device according to claim 1, further comprising:
a control unit configured to cause the display device to display the object on the display image, wherein the object is in a respective form which corresponds to each user identified by the identification unit.

10. The information processing device according to claim 1, wherein the detection data includes an image including the at least one user within the nearby region.

11. The information processing device according to claim 10, wherein the acquisition unit is configured to acquire another image captured in a direction different from a direction in which the image has been captured and including the display image and to acquire the position data of the object using the other image.

12. The information processing device according to claim 10,
wherein the image includes the display image, and
wherein the acquisition unit is configured to acquire the position data of the object, using the image.

13. The information processing device according to claim 1, wherein the object is superimposed on the display image on the basis of a result of detecting the position of at least a part of the object within the display image.

14. The information processing device according to claim 1, wherein the acquisition unit is configured to acquire the detection data via one interface and acquires the position data via another interface different from the one interface.

15. An information processing method comprising:
acquiring detection data by processing a first detection result output from a first sensor configured to detect at least a feature of a user in a nearby region near a display device;
acquiring position data by processing a second detection result output from a second sensor configured to detect a position of at least a part of an object in a display image displayed by the display device; and
identifying a user who would have written the object onto the display image by using the detection data and the position data.

16. A display method comprising:
detecting at least a user in a nearby region near a display device and a position of the user when an object is written into a display image displayed by the display device; and
causing the display device to display, on the display image, using information of at least the position, an object which is associated with the user and which is in a corresponding form that corresponds to the user.
